(19) United States
(12) Patent Application Publication
(10) Pub. No.: US 2024/0008008 A1
(43) Pub. Date: Jan. 4, 2024

(54) DETERMINING THE RESOURCE ELEMENTS FOR TRANSPORT BLOCK SIZE DETERMINATION FOR A TRANSPORT BLOCK SPANNING MULTIPLE SLOTS

(71) Applicant: NOKIA TECHNOLOGIES OY, Espoo (FI)

(72) Inventors: Nhat-Quang NHAN, Reims (FR); Keeth Saliya Jayasinghe LADDU, Espoo (FI); Marco MASO, Issy les Moulineaux (FR); Alessio MARCONE, Munich (DE)

(21) Appl. No.: 18/252,614

(22) PCT Filed: Dec. 31, 2021
(86) PCT No.: PCT/EP2021/087893

§ 371 Date: May 11, 2023

Related U.S. Application Data
(60) Provisional application No. 63/138,677, filed on Jan. 18, 2021.

(51) Int. Cl. H04W 72/0446; H04L 5/00

(52) U.S. Cl. CPC H04W 72/0446; H04L 5/0044

(57) ABSTRACT

Methods and apparatus, including computer program products, are provided for multi-slot transport block size determination. In some example embodiments, there may be provided a method that includes calculating a number of resource elements allocated within a resource element set based at least on an overhead value used for transport block size determination of a transport block that is transmitted over multiple slots; calculating a total number of resource elements, allocated for a physical uplink shared channel or a physical downlink shared channel, covering multiple slots for the transport block size determination based at least on the calculated number of resource elements allocated within the resource element set; and transmitting or receiving the transport block over multiple slots. Related systems, methods, and articles of manufacture are also disclosed.

### FIELD

The subject matter described herein relates to wireless communications.

### BACKGROUND

In the current, legacy 3GPP RANI specifications, a user equipment (UE) may determine a transport block size (TBS) for a physical downlink shared channel (PDSCH) transmission or a physical uplink shared channel (PUSCH) transmission by initially determining a total number of resource elements (N_{RE}) allocated for the transmission within a time slot (also referred to as a slot). The total number of resource elements N_{RE} is then used for the calculation of an unquantized intermediate variable N_{info}=N_{RE}·R·Qₘ·v, where R, Qₘ, and v are coding rate, modulation order, and number of layers, respectively (and “·” denotes multiplication). Next, the unquantized intermediate variable N_{inf o} is quantized and mapped to a valid transport block size specified in tables (e.g., if N_{inf o}≤3824) or algorithms (e.g., if N_{inf o}>3824) as described in 3GPP TS 38.214, section 5.1.3.2.

With respect to the determining of the total number of resource elements N_{RE}, 3GPP TS 38.214 may impose further requirements on the UE as shown in Table 1.

TABLE 1
A UE first determines the number of REs allocated for PDSCH within a physical
resource block (PRB) by:
N′_{RE} = N_{sc}^{RB} · N_{symb}^{sh} − N_{DMRS}^{PRB} − Nₒₕ^{PRB},
where (N′_{RE}) refers to the number of REs allocated for the PDSCH within a physical
resource block (PRB), N_{sc}^{RB} = 12 is the number of subcarriers in a physical resource
block, N_{symb}^{sh} is the number of symbols of the PDSCH allocation within the slot, N_{DMRS}^{PRB}
is the number of resource elements (REs) for DM-RS per PRB in the scheduled
duration including the overhead of the DM-RS CDM groups without data, as indicated
by DCI format 1_1 or format 1_2 or as described for format 1_0 in clause 5.1.6.2 of
3GPP TS38.214, and Nₒₕ^{PRB} is the overhead configured by higher layer parameter
xOverhead in PDSCH-ServingCellConfig. If the xOverhead in PDSCH-
ServingCellconfig is not configured (a value from 0, 6, 12, or 18), the Nₒₕ^{PRB} is set to
0. If the PDSCH is scheduled by the PDCCH with a CRC scrambled by SI-RNTI, RA-
RNTI, MsgB-RNTI or P-RNTI, Nₒₕ^{PRB} is assumed to be 0.
A UE determines the total number of REs (N_{RE}) allocated for PDSCH by N_{RE} =
min (156, N′_{RE}) · n_{PRB}, where n_{PRB} is the total number of allocated PRBs for the
UE.

### SUMMARY

In some example embodiments, there may be provided a method that includes calculating a number of resource elements allocated within a resource element set based at least on an overhead value used for transport block size determination of a transport block that is transmitted over multiple slots; calculating a total number of resource elements, allocated for a physical uplink shared channel or a physical downlink shared channel, covering the multiple slots for the transport block size determination based at least on the calculated number of resource elements allocated within the resource element set; and transmitting or receiving the transport block over the multiple slots.

In some variations, one or more of the features disclosed herein including the following features can optionally be included in any feasible combination. The calculating of the total number of resource elements may be further based at least on a value that defines a maximum number of resource elements for a single slot, wherein the value is scaled by at least an actual number of slots over which the transport block is transmitted. The calculating of the total number of resource elements may be further based at least on one or more values of a maximum number of resource elements that are allocated for transmitting the transport block over multiple slots, wherein the maximum number of resource elements correspond to at least one of the actual number of slots over which the transport block is transmitted or corresponds to at least one of an actual number of symbols over which the transport block is transmitted, wherein the one or more values are configured via higher layer signaling. The calculating of the total number of resource elements may be further based at least on one or more values of a maximum number of resource elements that are allocated for transmitting the transport block over multiple slots, wherein the one or more values of the maximum number of resource elements are calculated by multiplying an actual number of symbols over which the transport block is transmitted and a number of the resource elements per the resource element set per symbol. The one or more calculated values of the maximum number of resource elements may be reduced by a scalar value, wherein the actual number of symbols is reduced by the scalar value, and/or wherein the scalar value is equal to the overhead value. The resource element set may be a physical resource block or a number of subcarriers. The overhead value may be determined based at least on the actual number of slots over which the transport block is transmitted or on the actual number of symbols over which the transport block is transmitted. The overhead value may be determined based at least on a number of the multiple slots. The overhead value may be determined based at least on a scaling of a first value of xOverhead, wherein the scaling modifies the first value by an actual number of slots over which the transport block is transmitted, by the actual number of symbols over which the transport block is transmitted, or by a scaling factor. The actual number of slots may be defined by a ceil function of the actual number of symbols across the multiple slots over which the transport block is transmitted divided by a maximum number of symbols within a slot, or wherein the actual number of slots over which the transport block is transmitted is defined by the actual number of symbols across the multiple slots over which the transport block is transmitted divided by the maximum number of symbols within the slot.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of transport blocks transmitted via respective single slots and a transport block transmitted via multiple slots, in accordance with some example embodiments;

FIG. 2 depicts examples of slot allocations including full slot length per slot, mini-slot allocation with the same allocated symbols per slot, and the mini-slot allocation with different allocated symbols across slots, in accordance with some example embodiments;

FIG. 3 depicts an example of a process 300 for transport block size determination, in accordance with some example embodiments.

FIG. 4A depicts an example of a network node, in accordance with some example embodiments; and

FIG. 4B depicts an example of an apparatus, in accordance with some example embodiments.

Like labels are used to refer to same or similar items in the drawings.

### DETAILED DESCRIPTION

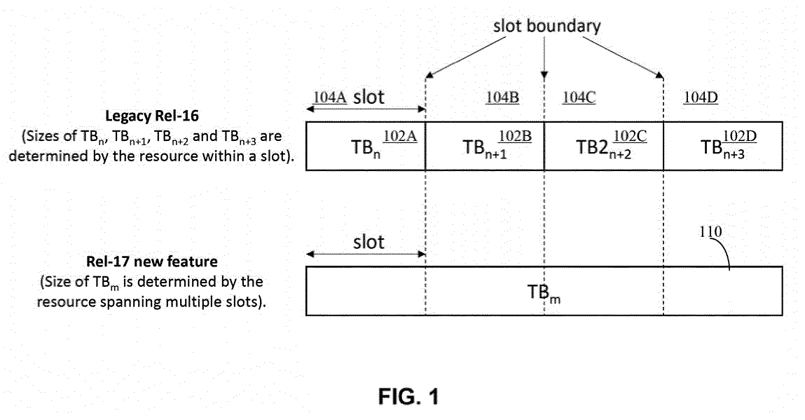

There is a need to support transport block (TB) processing over multiple slots of the physical uplink shared channel (PUSCH) or the physical downlink shared channel (PDSCH), wherein the transport block size is determined based on multiple slots and transmitted over multiple slots. See, e.g., RAN #90-e, Dec. 7-11, 2020, RP-202928. FIG. 1 depicts transport blocks n through n+3 102A-D, each of which is transmitted via a respective single slot (also referred to as a time slot) of a subframe or frame. By contrast, the transport block 110 is transmitted over multiple slots 104A-D.

With a transport block (TB) that is determined and transmitted by the resource of multiple slots as shown at 110 of FIG. 1, the current, legacy transport block size determination algorithm at the UE may need to be modified to cope with the fact that the maximum resource elements for a transport block size determination may go beyond one slot. As such, this may cause one or more problems, and these problems may occur when applying a legacy transport block size determination procedure (as described in the background above) to a scenario of a transport block that is determined and transmitted by the resource of multiple slots (referred to herein as a “multi-slot transport block”).

With respect to the UE's calculation of the number (e.g., quantity) of resource elements that are allocated within a resource element set, denoted as N′_{RE}, the legacy transport block size determination procedure assumes that the resource element set represents a physical resource block (PRB). Although some of the examples refer to a physical resource block, other types of blocks or resource sets may be used as well.

The application of a legacy transport block size determination procedure in the case of a transport block determined and transmitted by a resource of multiple slots (which as noted is also referred to herein as a “multi-slot transport block”) may cause as noted problems. For the calculation of N′_{RE}, one may scale N_{symb}^{sh} and N_{DMRS}^{PRB} for the multi-slot transport block scenario by considering all the physical uplink shared channel (PUSCH) symbols or physical downlink shared channel (PDSCH) symbols that are allocated across a multi-slot transport block (for N_{symb}^{sh}) and all demodulation reference signal (DMRS) symbols within the allocated resource (for N_{DMRS}^{PRB}).

Conversely, the scaling operation is not straightforward for the determination of Nₒₕ^{PRB} (which is the overhead configured by a higher layer parameter xOverhead of the PDSCH-ServingCellConfig) in the multi-slot transport block scenario. Per the current, legacy standard, the Nₒₕ^{PRB} may be semi-statically configured based on the radio resource control (RRC) parameter, xOverhead found in the PUSCH-ServingCellConfig (or PDSCH-ServingCellConfig in the case of PDSCH transmission), so the Nₒₕ^{PRB} takes on the value from the set of values of {6, 12, 18} or the value 0 if xOverhead is not configured.

However, to define xOverhead for the multi-slot transport block scenario, the xOverhead may need to be extended to include additional values, such as {6, 12, 18, A₁, A₂, . . . A_{N}}, where A₁, A₂, . . . A_{N} are positive integers greater than 18. More importantly, there is a need for a new approach to mapping each value in the set of xOverhead to a corresponding length (or range of lengths) of the multi-slot transport block. As the length of multi-slot transport block varies (e.g., the length may be greater than a single slot), a single value of xOverhead that is semi-statically configured cannot be used for different lengths of multi-slot transport block.

With respect to the UE's calculation of the total number of resource elements allocated for physical uplink shared channel (PUCCH) or physical downlink shared channel (PDSCH), denoted as N_{RE}, the application of the legacy transport block size determination procedure for the multi-slot transport block may also cause problems. In the current, legacy 3GPP NR specification (e.g., Rel-16), the transport block size (TBS) of the shared data channel can only be determined and the transport block (TB) can only be transmitted by a number of symbols within a single time slot per transmission (e.g., a slot of 14 symbols, where a maximum of 13 symbols are used to determine the transport block size and to transmit the transport block). In this case for example, the value 156 is specified as the maximum number of resource elements allocated for transmitting the transport block over a single slot. This value may not be suitable for the multi-slot transport block scenario given that the number of symbols used for the transmission of the transport block might be larger than 13, for example. As a result, the value of 156 may need to be scaled based on the total actual number of symbols that are used across multiple slots to convey the multi-slot transport block.

In some example embodiments, a precise calculations of N′_{RE} and/or N_{RE}, that can be applicable across a wide range of scenarios including the multi-slot transport block scenario, is provided.

With respect to UE's calculation of N′_{RE} in the multi-slot transport block scenario, various solutions may be implemented as described below.

In some example embodiments, there is provided a semi-static configuration, via higher-layer signaling (e.g., values obtained by a user equipment through radio resource control signal with a base station or cell), for determining the xOverhead based on a number of actual slots defined by a ceil function of an actual number of symbols (which are across the multiple slots over which the transport block is transmitted) divided by a maximum number of symbols within a slot (e.g., 14 symbols in 3GPP NR specification). Alternatively, or additionally, the xOverhead may be determined based on an actual number of symbols (which are across the multiple slots over which the transport block is transmitted) divided by a maximum number of symbols within a slot (e.g., 14 symbols in 3GPP NR specification).

In some example embodiments, there is provided a semi-static configuration, via the higher-layer signaling (e.g., values obtained by a user equipment through radio resource control signal with a base station or cell), for determining the xOverhead based on a number of actual symbols defined by the size of some if not all of (e.g., a set or a subset) the set of symbols (configured via higher layer signaling) over which the transport block is actually transmitted.

In some example embodiments, there is provided a semi-static configuration, via the higher-layer signaling (e.g., values obtained by a user equipment through radio resource control signal with a base station or cell), for determining the xOverhead based on a nominal number of slots, which is the number of slots spanned by the multi-slot transport block (e.g., the number of slots the multi-slot transport block spans across).

In some example embodiments, there is provided a single value of xOverhead that is semi-statically configured via the higher-layer signaling (e.g., values obtained by a user equipment through radio resource control signal with a base station or cell). This single value may be the single value used for a single slot transport block but, in accordance with some example embodiments, scaled for a multi-slot transport block. For example, the single value may be scaled by multiplying the single value by the actual number of allocated slots. Alternatively, or additionally, this single value may be scaled by adding (or subtracting) an integer α (which is further described below).

With respect to the user equipment's calculation of the total number of resource elements allocated for physical downlink shared channel (PDSCH) or physical uplink shared channel (PUSCH) (e.g., the N_{RE}) in the multi-slot transport block transmission scenario, the following three solutions for the determination of maximum number of resource elements allocated for transmitting the transport block over multiple slots are provided.

In some example embodiments, there is provided a scaling of the aforementioned maximum number of resource elements allocated for transmitting the transport block over a single slot (e.g., the value 156) based on the actual number of slots.

In some example embodiments, there is provided a semi-static configuration, via higher-layer signaling (e.g., RRC signaling), of one or more values of maximum number of resource elements allocated for transmitting the transport block over multiple slots corresponding to the actual number of slots or the actual number of symbols over which the transport block is transmitted. This one or more values may be jointly configured in the same table with xOverhead.

In some example embodiments, there is provided a calculation of a value of maximum number of resource elements allocated for transmitting the transport block over multiple slots, wherein the value may be calculated by multiplying a number of resource elements per resource element set per symbol and an actual number of symbols over which the transport block is transmitted. Alternatively, or additionally, the value may be calculated by multiplying a number of resource elements per resource element set per symbol and an actual number of symbols over which the transport block is transmitted and reduced (e.g., subtracted) by a scalar value. This scalar value may be the overhead value (e.g., xOvherhead); Alternatively, or additionally, the value may be calculated by multiplying a number of resource elements per resource element set per symbol and an actual number of symbols over which the transport block is transmitted, wherein the actual number of symbols over which the transport block is transmitted is reduced by a scalar value.

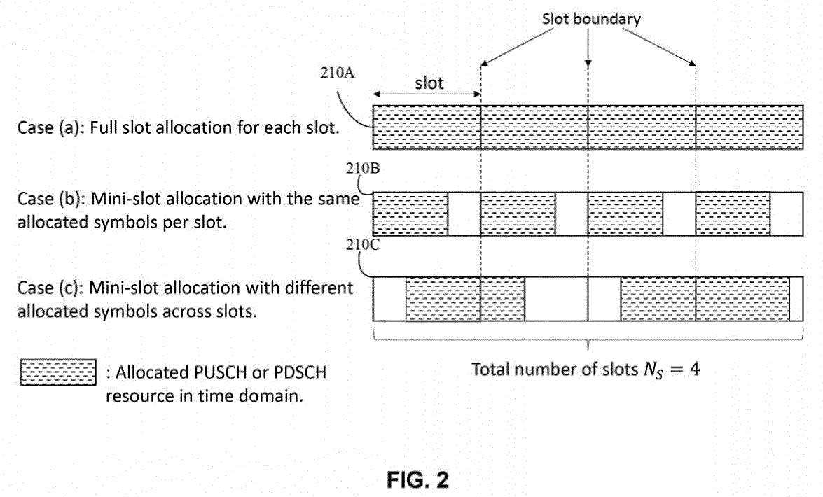

There are at least three possibilities for time domain resource allocation of physical uplink shared channel (PUSCH) and/or physical downlink shared channel (PDSCH) on the slots used for the multi-slot transport block transmission. The time domain PUSCH/PDSCH resources may be allocated with a full slot length per slot, a mini-slot allocation with the same allocated symbols per slot, or a mini-slot allocation with different allocated symbols across slots). FIG. 2 depicts the slot allocation and, in particular, the full slot length per slot 210A, the mini-slot allocation with the same allocated symbols per slot 210B, and the mini-slot allocation with different allocated symbols across slots 210C.

If the number of symbols per slot is the same as in 210A and 210B, the N′_{RE} and the N_{RE} may be linearly scaled by the total number of slots N_{S} using xOverhead semi-statically configured for the first slot. But this approach may not work for 210C, where the number of symbols is different across the N_{S} slots. In addition, this linear scaling may not provide flexibility when the xOverhead value does not scale linearly with the number of total number of slots N_{S}. To address this and/or other problems, a solution that provides additional flexibility while enabling applicability to all three cases 210A-C is described below.

In some example embodiments, there is provided a way of calculating N′_{RE}. To that end, N_{symb,i} is defined as the number of symbols used for multi-slot transport block transmission in the i^{th} slot. The total number of symbols used for multi-slot transport block transmission across N_{S} slots is defined as

N_{bundled}_{_{symb}}=Σᵢ₌₁^{N}^{_{S}}N_{symb,i}

where N_{S} denotes the total nominal number of slots, N_{symb,i} denotes the number of symbols used for multi-slot transport block transmission in the i^{th} slot, and where all or part of the symbols in the slots are used for the multi-slot transport block transmission. Alternatively, or additionally, N_{S} may denote the number of slots from the first and the last slots that have all or part of the symbols that are used for multi-transport block transmission (e.g., including the case one or more slots in between the first and last slot is/are not used for multi-transport block transmission).

With respect to the indication of xOverhead, this may be determined in a variety of ways, in accordance with some example embodiments. For example, a semi-static configuration may be provided, via the higher-layer signaling (e.g., RRC) of values, to determine the xOverhead based on the actual number of slots over which the transport block is transmitted N_{AS}, which is defined by:

$${N}_{AS} = ⌈ \frac{{N}_{bundled \_ symb}}{maximum number of symbols per slot ( e . g \text{.14} )} ⌉ ,$$

where [A] is ceil function that returns the smallest integer value that is bigger than or equal to A. To illustrate by way of an example, Table 2 may be used to configured, via the higher-layer signaling, the xOverhead to be used for the multi-slot transport block configuration.

TABLE 2

| N_{AS} | xOverhead |
|---|---|
| 1 | One value from the set of |
| | (Jun. 12, 2018) |
| 2 | One value from the set of |
| | (A₁, B₁, C₁, . . .) |
| 3 | One value from the set of |
| | (A₂, B₂, C₂, . . .) |
| 4 | One value from the set of |
| | (A₃, B₃, C₃, . . .) |
| . . . | . . . |

In Table 2, A₁, A₂, A₃, B₁, B₂, B₃, and so forth. are positive integers that represent overhead resource elements that account for the presence of channel state information-reference signal, phase tracking reference signal, and/or other factors. Additional candidate values may be defined that are applicable for a given N_{AS}, but only one value may be configured such that the UE understands which value should be selected for a given N_{AS}. For example, if the value per given N_{AS} is not configured, a default assumption may be further defined to be used in the transport block size calculation. Alternatively, or additionally, a different N_{AS} may be also configured with the same value of xOverhead.

Alternatively, or additionally, in some example embodiments, there is provided a semi-static configuration, via the higher-layer signaling values (e.g., RRC), for the xOverhead that is associated with a nominal number of slots N_{S}, which is the number of slots spanned by the multi-slot transport block. For example, Table 2 may also be used, but N_{AS} is replaced by the total nominal number of slots, N_{S}. Considering a similar higher-layer configuration (as above) where only one candidate value is configured per N_{S}, the user equipment may derive the exact xOverhead dynamically for the transport block size calculation. By using some of the fields (e.g., time domain resource allocation, number of slots, and/or the like) in downlink control information (DCI) for example, the UE may implicitly derive the xOverhead.

Alternatively, or additionally, in some example embodiments, there is provided a single value of xOverhead that is semi-statically configured the higher-layer signaling (i.e., values obtained by UE through RRC). This single value is used for a single slot transport block but scaled for a multi-slot transport block. For example, the single value may be scaled by multiplying the single value by the actual number of allocated slots, N_{AS}, as follows:

xOverhead=N_{AS}×xOverhead_single_slot,

where xOverhead_single_slot denotes the single value used for a single slot transport block, N_{AS} denotes the actual number of allocated slots, and xOverhead denotes the overhead value used for a multi-slot transport block.

Alternatively, or additionally, the single value may be modified by adding an integer value α, as follows:

xOverhead=xOverhead_single_slot+α,

where xOverhead_single_slot denotes the single value is used for a single slot transport block, and α denotes the scaling factor or integer value which is added, and xOverhead denotes the overhead value used for a multi-slot transport block.

The integer value of α (which is also referred to herein as a scaling factor, for simplicity) may be determined from N_{S} and/or N_{AS}. For example, the integer α can be configured via higher-layer signaling as shown in Table 3 below.

TABLE 3

| (N_{S} − N_{AS}) slots or | |
|---|---|
| (14 × N_{S} − N_{bundled}_{_{—}}_{symb}) symbols | α |
| β₁ | α₁ |
| β₂ | α₂ |
| β₃ | α₃ |
| . . . | . . . |

In Table 3, α₁, α₂, α₃ . . . and β₁, β₂, β₃ . . . are integers. Alternatively, or additionally, the integer α may be directly specified with values corresponding to certain thresholds depending on the difference between N_{S} and N_{AS}. Alternatively, or additionally, a can be dynamically indicated via DCI.

When calculating N′_{RE}, the values of Nₛₕ^{symb} and N_{DMRS}^{PRB} may take the values of N_{bundled_symb} and the number of allocated DMRS symbols within the N_{bundled_symb} symbols, respectively.

With respect to the calculation of N_{RE}, after N′_{RE} is calculated correctly with the actual time domain resource across multiple slots, the calculation of N_{RE} may be further based at least on a value that defines the maximum number of resource elements allocated for transmitting the transport block over multiple slots, in accordance with some example embodiments.

In some example embodiments, the value may be provided by scaling the maximum number of resource elements allocated for transmitting the transport block over a single slot (e.g., 156 in 3GPP NR specification Rel-16) based on one or more of the scaling alternatives disclosed herein. For example, this value may be scaled by N_{AS} and the N_{RE} may be calculated by:

N_{RE}=min(N_{AS}×156,N′_{RE})·n_{PRB},

where NAS denotes the number of actual slots, “min” denotes a minimum operation, n_{PRB} denotes the total number of allocated resource element sets (e.g. number of allocated physical resource blocks) for the UE, and NE denotes the calculated number of resource elements that are allocated within a resource element set.

In some example embodiments, one more values of maximum number of resource elements allocated for transmitting the transport over multiple slots may be semi-statically configured via higher-layer signaling (e.g., RRC) corresponding to the actual number of slots (N_{AS}) or the actual number of symbols over which the transport block is transmitted (N_{bundled_symb}) This one or more of values may be jointly configured in the same table with xOverhead as in the following example depicted at Table 4.

TABLE 4

| N_{AS}/ | | Value for N_{RE} |
|---|---|---|
| N_{bundled}_{_{—}}_{symb} | xOverhead | calculation |
| 1 | Jun. 12, 2018 | 156 |
| 2 | One value from | D₁ |
| | (A₁, B₁, C₁, . . .) | |
| 3 | One value from | D₂ |
| | (A₂, B₂, C₂, . . .) | |
| 4 | One value from | D₃ |
| | (A₃, B₃, C₃, . . .) | |
| . . . | . . . | . . . |

In Table 4, D₁, D₂, D₃ . . . are also positive integers that represent the maximum number of resource elements that may be considered for transport block size determination for a given N_{AS}.

In some example embodiments, the value of the maximum number of resource elements allocated for transmitting the transport block over multiple slots may be calculated by multiplying a number of resource elements per resource element set per symbol (e.g., 12 symbols) and an actual number of symbols over which the transport block is transmitted (N_{bundled_symb}) Accordingly, the N_{RE} may be calculated by:

N_{RE}=min(12*N_{bundled}_{_{symb}},N′RE)·n_{PRB},
In some example embodiments, the value of maximum number of resource elements allocated for transmitting the transport block over multiple slots may be calculated by multiplying a number of resource elements per resource element set per symbol (e.g., 12 symbols) and an actual number of symbols over which the transport block is transmitted (N_{bundled_symb}) and reduced (e.g., subtracted) by a scalar value X, wherein the scalar value X may be the overhead value (i.e. xOverhead). Accordingly, the N_{RE} may be calculated by:

N_{RE}=min(12*N_{bundled}_{_{symb}}−xOverhead,N′_{RE})·n_{PRB}

In some example embodiments, the value of maximum number of resource elements allocated for transmitting the transport block over multiple slots may be calculated by multiplying a number of resource elements per resource element set per symbol (e.g., 12 symbols) and an actual number of symbols over which the transport block is transmitted (N_{bundled_symb}), wherein the actual number of symbols over which the transport block is transmitted is reduced by a scalar value Y, wherein Y may be the number of overhead symbols. Accordingly, the N_{RE} may be calculated by:

N_{RE}=min(12*N_{bundled}_{_{symb}}−Y),N′_{RE})·n_{PRB}

where Y denotes the number of overhead symbols, and an overhead symbol may contain at least one overhead resource element.

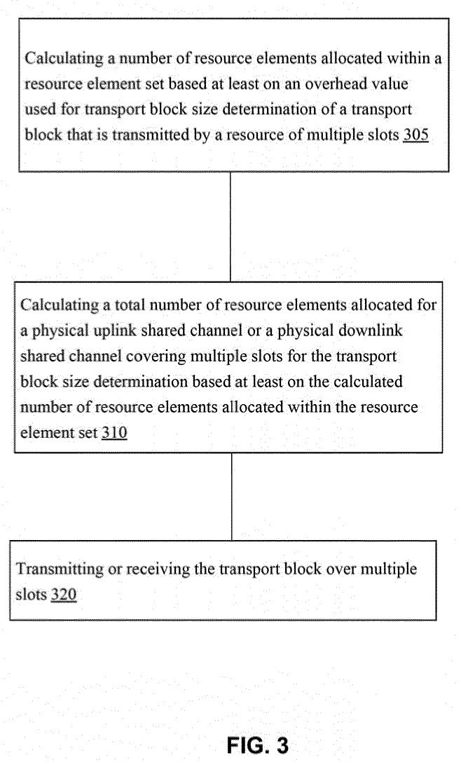

FIG. 3 depicts an example of a process 300 for multi-slot transport block size determination, in accordance with some example embodiments.

At 305, a calculation may be performed for a number of resource elements allocated within a resource element set (e.g., a physical resource block) based at least on an overhead value used for transport block size determination of a transport block that is transmitted by a resource of multiple slots. For example, N′_{RE} may be calculated for the multi-slot transport block scenario. And, this N′_{RE} calculation may be determined based on the overhead value calculations described herein with respect to xOverhead, for example. In some example embodiments, the overhead value may be determined based at least on an actual number of slots or an actual number of symbols over which the transport block is transmitted. Alternatively, or additionally, the overhead value may be determined based at least on a number of the multiple slots. Alternatively, or additionally, the overhead value may be determined based at least on a scaling of a first value of xOverhead. The scaling may modify the first value by the actual number of slots or the actual number of symbols within which the transport block is transmitted and/or by a scaling factor. In some example embodiments, the overhead value may be configured via higher-layer signaling such as radio resource control signaling.

At 310, a calculation may be performed for a total number of resource elements allocated for a physical uplink shared channel (PUSCH) or a physical downlink shared channel (PDSCH) covering multiple slots based at least on the calculated number of resource elements allocated within a resource element set (e.g., a physical resource block). The total number of resource elements calculation may be further based at least on a value that defines the maximum number of resource elements allocated for transmitting the transport block over multiple slots. The value may be provided by scaling at least the maximum number of resource elements allocated for transmitting the transport block over a single slot based on the number of an actual time-domain resources. Alternatively, or additionally, the total number of resource elements calculation may be further based at least on one or more values of the maximum number of resource elements allocated for transmitting the transport block over multiple slots corresponding to an actual time-domain resource. The one or more values of maximum number of resource elements (which are allocated for transmitting the transport block over multiple slots) may be configured via higher-layer signaling such as radio resource control signaling. Alternatively, or additionally, the total number of resource elements calculation may be further based at least on one or more values of the maximum number of resource elements (which are allocated for transmitting the transport block over multiple slots) calculated by multiplying a number of resource elements per resource element set per symbol and an actual number of symbols over which the transport block is transmitted; or by multiplying a number of resource elements per resource element set per symbol and an actual number of symbols over which the transport block is transmitted and further reducing (e.g., subtracting) by a scalar value, wherein the scalar value may be the overhead value (e.g., xOvherhead); or by multiplying a number of resource elements per resource element set per symbol and an actual number of symbols over which the transport block is transmitted, wherein the actual number of symbols over which the transport block is transmitted is further reduced by a scalar value. In some example embodiments, the calculation may correspond to the above-noted calculation of the N_{RE}.

At 320, the transport block may be transmitted or received over multiple slots, in accordance with some example embodiments. For example, a user equipment may transmit a transport block over multiple slots on the PDSCH or other type of uplink to a base station. Alternatively, or additionally, the user equipment may receive a transport block over multiple slots on the PDSCH or other type of downlink from a base station. Alternatively, or additionally, a base station may transmit a transport block over multiple slots on the PDSCH or other type of downlink to the user equipment. Alternatively, or additionally, the base station may receive a transport block over multiple slots on the PUSCH or other type of uplink from a user equipment. As used herein, the “actual number of symbols” over which the transport block is transmitted may refer to a number of symbols over which the transport block is actually transmitted, wherein the number of symbols may refer to some if not all of the set of symbols provided via higher-layer signaling (e.g., RRC signaling).

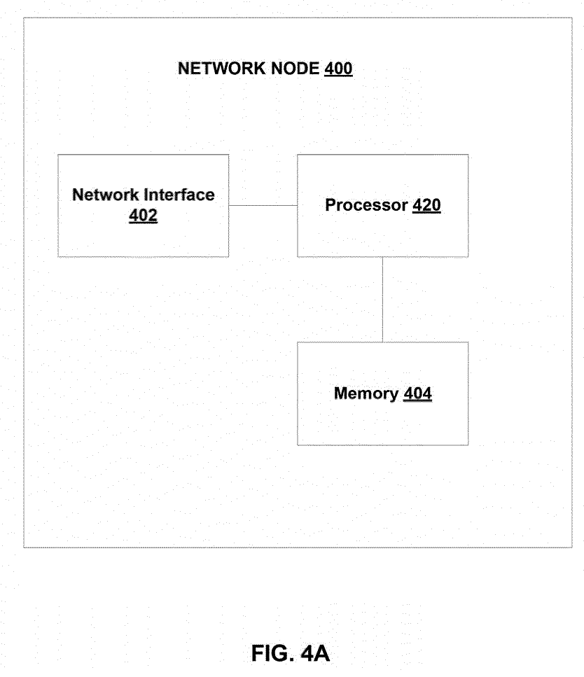

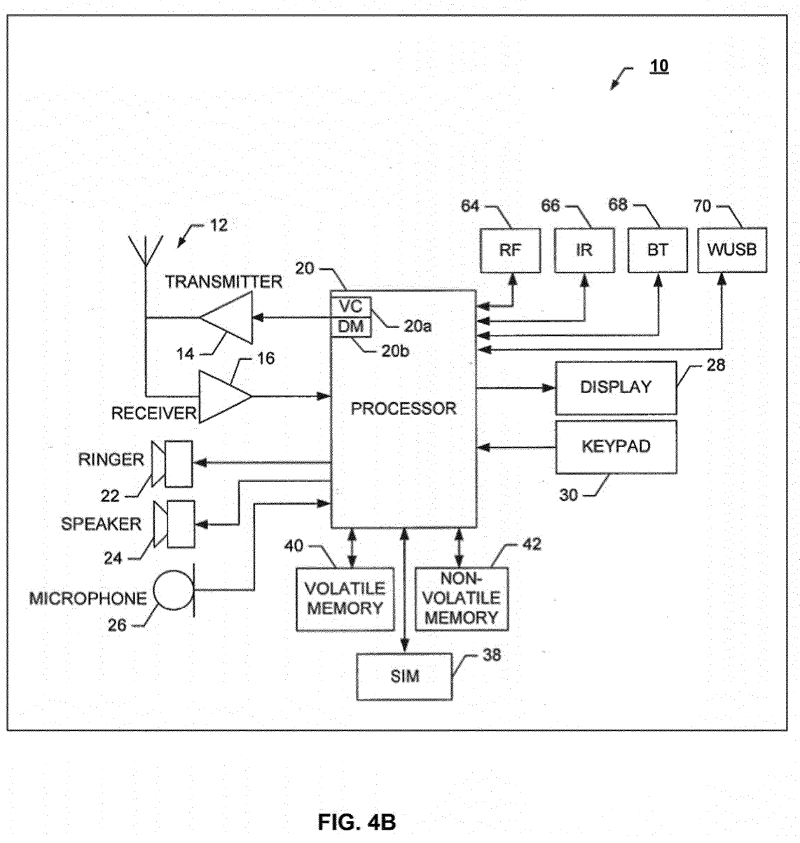

FIG. 4A depicts a block diagram of a network node 400, in accordance with some example embodiments. The network node 400 may be configured to provide one or more network side nodes or functions, such as a base station (e.g., gNB, eNB, and/or the like) configured to size, transmit, and/or receive at least one transport block over multiple slots to a user equipment.

The network node 400 may include a network interface 402, a processor 420, and a memory 404, in accordance with some example embodiments. The network interface 402 may include wired and/or wireless transceivers to enable access other nodes including base stations, other network nodes, the Internet, other networks, and/or other nodes. The memory 404 may comprise volatile and/or non-volatile memory including program code, which when executed by at least one processor 420 provides, among other things, the processes disclosed herein with respect to the network nodes.

FIG. 4B illustrates a block diagram of an apparatus 10, in accordance with some example embodiments. The apparatus 10 may represent a user equipment. The user equipment may be configured to determine a size of the transport block spanning multiple slots, wherein the multi-slot transport block is being received by the user equipment. For example, the user equipment may need to determine the transport block size of a transport block spanning multiple slots in order to be able to properly receive, transmit, and/or decode the transport block.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4B as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor may additionally comprise an internal voice coder (VC) 20a, an internal data modem (DM) and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 4B, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the UE (e.g., one or more of the processes, calculations, and the like disclosed herein including the process at FIG. 3).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiments, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may be enhanced handling of transport blocks spanning multiple time slots.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1-23. (canceled)

24. A method comprising:
calculating, by an apparatus, a number of resource elements allocated within a resource element set based at least on an overhead value used for transport block size determination of a transport block that is transmitted over multiple slots;
calculating a total number of resource elements, allocated for a physical uplink shared channel or a physical downlink shared channel, covering the multiple slots for the transport block size determination based at least on the calculated number of resource elements allocated within the resource element set; and
transmitting or receiving the transport block over the multiple slots.

25. The method of claim 24, wherein the calculating of the total number of resource elements is further based at least on a value that defines a maximum number of resource elements for a single slot, wherein the value is scaled by at least an actual number of slots over which the transport block is transmitted.

26. The method of claim 25, wherein the actual number of slots is defined by a ceil function of the actual number of symbols across the multiple slots over which the transport block is transmitted divided by a maximum number of symbols within a slot, or wherein the actual number of slots over which the transport block is transmitted is defined by the actual number of symbols across the multiple slots over which the transport block is transmitted divided by the maximum number of symbols within the slot.

27. The method of claim 24, wherein the calculating of the total number of resource elements is further based at least on one or more values of a maximum number of resource elements that are allocated for transmitting the transport block over multiple slots, wherein the maximum number of resource elements corresponds to at least one of the actual number of slots over which the transport block is transmitted or corresponds to at least one of an actual number of symbols over which the transport block is transmitted, wherein the one or more values are configured via higher layer signaling.

28. The method of claim 24, wherein the calculating of the total number of resource elements is further based at least on one or more values of a maximum number of resource elements that are allocated for transmitting the transport block over multiple slots, wherein the one or more values of the maximum number of resource elements are calculated by multiplying an actual number of symbols over which the transport block is transmitted and a number of the resource elements per the resource element set per symbol.

29. The method of claim 28, wherein the one or more calculated values of the maximum number of resource elements are reduced by a scalar value, wherein the actual number of symbols is reduced by the scalar value, and/or wherein the scalar value is equal to the overhead value.

30. The method of claim 24, wherein the overhead value is determined based at least on the actual number of slots over which the transport block is transmitted or on the actual number of symbols over which the transport block is transmitted.

31. The method of claim 24, wherein the overhead value is determined based at least on a number of the multiple slots.

32. The method of claim 24, wherein the overhead value is determined based at least on a scaling of a first value of xOverhead, wherein the scaling modifies the first value by an actual number of slots over which the transport block is transmitted, or by an actual number of symbols over which the transport block is transmitted, or by a scaling factor.

33. An apparatus comprising:
at least one processor; and
at least one memory including computer program code, the at least one memory and the computer program code configured to, with the at least one processor, cause the apparatus to at least:
calculate a number of resource elements allocated within a resource element set based at least on an overhead value used for transport block size determination of a transport block that is transmitted over multiple slots;
calculate a total number of resource elements, allocated for a physical uplink shared channel or a physical downlink shared channel, covering the multiple slots for the transport block size determination based at least on the calculated number of resource elements allocated within the resource element set; and
transmit or receive the transport block over the multiple slots.

34. The apparatus of claim 33, wherein the total number of resource elements calculation is further based at least on a value that defines a maximum number of resource elements for a single slot, wherein the value is scaled by at least an actual number of slots over which the transport block is transmitted.

35. The apparatus of claim 34, wherein the actual number of slots is defined by a ceil function of the actual number of symbols across the multiple slots over which the transport block is transmitted divided by a maximum number of symbols within a slot, or wherein the actual number of slots over which the transport block is transmitted is defined by the actual number of symbols across the multiple slots over which the transport block is transmitted divided by the maximum number of symbols within the slot.

36. The apparatus of claim 33, wherein the total number of resource elements calculation is further based at least on one or more values of a maximum number of resource elements that are allocated for transmitting the transport block over multiple slots, wherein the maximum number of resource elements correspond to at least one of the actual number of slots over which the transport block is transmitted or corresponds to at least one of an actual number of symbols over which the transport block is transmitted, wherein the one or more values are configured via higher layer signaling.

37. The apparatus of claim 33, wherein the total number of resource elements calculation is further based at least on one or more values of a maximum number of resource elements that are allocated for transmitting the transport block over multiple slots, wherein the one or more values of the maximum number of resource elements are calculated by multiplying an actual number of symbols over which the transport block is transmitted and a number of the resource elements per the resource element set per symbol.

38. The apparatus of claim 37, wherein the one or more calculated values of the maximum number of resource elements are reduced by a scalar value, wherein the actual number of symbols is reduced by the scalar value, and/or wherein the scalar value is equal to the overhead value.

39. The apparatus of claim 33, wherein the resource element set is a physical resource block or a number of subcarriers.

40. The apparatus of claim 33, wherein the overhead value is determined based at least on the actual number of slots over which the transport block is transmitted or on the actual number of symbols over which the transport block is transmitted.

41. The apparatus of claim 33, wherein the overhead value is determined based at least on a number of the multiple slots.

42. The apparatus of claim 33, wherein the overhead value is determined based at least on a scaling of a first value of xOverhead, wherein the scaling modifies the first value by an actual number of slots over which the transport block is transmitted, by the actual number of symbols over which the transport block is transmitted, or by a scaling factor.

43. A non-transitory computer-readable storage medium including program code which when executed by at least one processor causes operations comprising:
calculating a number of resource elements allocated within a resource element set based at least on an overhead value used for transport block size determination of a transport block that is transmitted over multiple slots;
calculating a total number of resource elements, allocated for a physical uplink shared channel or a physical downlink shared channel, covering the multiple slots for the transport block size determination based at least on the calculated number of resource elements allocated within the resource element set; and
transmitting or receiving the transport block over the multiple slots.
